(19) United States
(12) Patent Application Publication
(10) Pub. No.: US 2023/0384084 A1
(43) Pub. Date: Nov. 30, 2023

(54) METHOD AND DEVICE FOR DETERMINING AN OPTIMIZED PARAMETER SET TO PERFORM A MEASUREMENT

(71) Applicant: TRUMPF Laser GmbH, Schramberg (DE)

(72) Inventors: Andreas Jahn, Dornhan (DE); Martin Stambke, Dunningen (DE)

(21) Appl. No.: 18/448,203

(22) Filed: Aug. 11, 2023

Related U.S. Application Data
(63) Continuation of application No. PCT/EP2022/051444, filed on Jan. 24, 2022.

(30) Foreign Application Priority Data
Feb. 25, 2021 (DE) 10 2021 201 806.8

(51) Int. Cl. G01B 9/02091

(52) U.S. Cl. CPC G01B 9/02091

(57) ABSTRACT

A method for determining an optimized parameter set having a plurality of measurement parameters to carry out a measurement is provided. The method includes: C) carrying out and storing n measurements of a measuring element, n being an integer greater than one. Each measurement has one parameter set. Each measurement has a multiplicity of measuring points. The method further includes: D) evaluating the n measurements with an evaluation function and storing the evaluation, E) generating new parameter sets from the parameter sets used in step C), F) carrying out steps C) to E) multiple times, and J) outputting at least one parameter set that is evaluated as good.

### CROSS REFERENCE TO RELATED APPLICATIONS

This application is a continuation of International Application No. PCT/EP2022/051444 (WO 2022/179776 A1), filed on Jan. 24, 2022, and claims benefit to German Patent Application No. DE 10 2021 201 806.8, filed on Feb. 25, 2021. The aforementioned applications are hereby incorporated by reference herein.

### FIELD

Embodiments of the present invention relate to a method and a device for determining an optimized parameter set.

### BACKGROUND

Complex measuring devices such as optical coherence tomography (OCT) measuring devices have numerous (setting) parameters which allow the user to adapt the measuring device to the respective measuring situation or processing situation of a measuring element. The multiplicity of parameters and their interactions result in a highly complex parameter space. The adjustment of the parameters of a parameter set therefore currently requires expert knowledge and is time-consuming.

### SUMMARY

Embodiments of the present invention provide a method for determining an optimized parameter set having a plurality of measurement parameters to carry out a measurement. The method includes: C) carrying out and storing n measurements of a measuring element, n being an integer greater than one. Each measurement has one parameter set. Each measurement has a multiplicity of measuring points. The method further includes: D) evaluating the n measurements with an evaluation function and storing the evaluation, E) generating new parameter sets from the parameter sets used in step C), F) carrying out steps C) to E) multiple times, and J) outputting at least one parameter set that is evaluated as good.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic view of a device according to embodiments of the present invention having a measuring device and a computer to carry out a method according to embodiments of the invention; and

FIG. 2 shows schematically the sequence of a method according to embodiments of the invention.

### DETAILED DESCRIPTION

Embodiments of the present invention provide a method and a device for automated determination of an optimized parameter set.

According to embodiments of the present invention, a method with the following, in particular automatically carried out, method steps:
C) carrying out and storing n measurements of a measuring element, in each case having one parameter set, wherein each measurement has a multiplicity of measuring points;
D) evaluating the n measurements with an evaluation function and storing the evaluation, wherein the evaluation is performed in particular gradually, preferably between 0 and 1;
E) generating, in particular, n new parameter sets, in particular by applying adaptation functions which take into consideration the evaluation from method step D) in the processing, selection and further use of the parameter sets;
F) multiple, in particular m-fold, performance of method steps C) to E);
J) outputting at least one parameter set, in particular the parameter set with the best evaluation. Further parameter sets can be output in addition to this.

The measurement parameters are necessary in order to be able to adapt the measurement to the multiplicity of processing situations. The complex and asymmetric parameter space with the multiplicity of parameters and interactions can be completely hidden from the user. No specific knowledge is therefore required for the operation. However, the functional scope and robustness with regard to the change in measuring situations, in component characteristics, are completely retained. Consequently, the method according to embodiments of the invention allows even inexperienced users to carry out a measurement with very good measurement parameters.

A parameter set corresponds to a number of measurement parameters with which a measurement is possible. Two parameter sets differ if at least one parameter of a parameter set is different from the same parameter in the other parameter set.

In method step E), the new parameter sets are generated, in particular, by applying evolutionary operators, preferably in the form of crossover operators and/or mutation operators, to the parameter sets used in method step C). If a crossover operator is applied, two parent parameter sets are combined to form one next-generation parameter set. If a mutation operator is applied, a single part/parts of a parent parameter set is/are randomly changed.

The measuring element can be present in the form of a workpiece.

n and/or m can be greater than 1, in particular greater than 2, preferably greater than 5, preferably greater than 10.

The measurement in method step C) is preferably carried out in the form of a contactless scan. The scan can be carried out one-dimensionally (line scan) or multi-dimensionally.

The measurement in method step C) is preferably carried out in the form of an optical coherence tomography (OCT) measurement or in the form of a pyrometry measurement. The parameter set for carrying out OCT measurements and pyrometry measurements is effectively optimizable with the method according to embodiments of the invention.

The evaluation function can comprise an algorithm, in particular in the form of an image processing algorithm, for evaluating the recording quality of the measurement, and/or a deep convolutional neural network. The algorithm can evaluate a raw sensor signal, for example a Fast Fourier Transform (FFT) signal. The image processing algorithm can be designed to evaluate the image quality of the measurement. The image processing algorithm can evaluate, for example, edge sharpness and/or image noise.

The n new parameter sets can be generated in method step E) randomly (E1) or (E2) using artificial intelligence (AI) which adapts its target function by means of an online learning method and the evaluations of the evaluation function. The AI achieves a significantly faster optimization of the parameter set through the continuous (online) performance of the learning method, taking into consideration the evaluations.

In a further preferred embodiment, the following method steps are carried out after method step F) and before method step J):
G) merging, in particular averaging, all of the measurements carried out in method step C);
H) defining the smallest possible region of interest (ROI) in this merged measurement in which the evaluation function exceeds a defined threshold value;
I) multiple, in particular o-fold, repetition of method steps C) to F), wherein the evaluation function in method step D) is applied within the ROI only.

The merging in method step G) can be carried out by averaging, by determining a median, and/or by determining other statistical values.

The ROI corresponds to the measurement area in which a measurement signal is received from the sampling element. The areas of the measurement in which no signal is received from the sampling element are thereby excluded from the optimization. The optimization is significantly improved as a result.

The ROI is preferably continuous.

o can be greater than 1, in particular greater than 2, preferably greater than 5, preferably greater than 10.

Following method step J), the parameter set output in method step J) can be stored in a method step K). In addition, one or more further parameter sets evaluated as good can be stored.

The following method step can be carried out before method step C):
B) generating the n parameter sets used in method step C):
   B1) randomly, or
   B2) by means of a default initial parameterization, or
   B3) by carrying out a measurement of the measuring element with a default initial parameterization, and determining one or more nearest neighbours of the default initial parameterization, in particular through density-based clustering. A plurality of nearest neighbours can be determined in a z-dimensional feature space through density-based clustering. The feature space can be defined using feature extraction methods, such as image processing methods and/or deep convolutional networks. z is preferably between 10 and 1000.

In addition, the following method step can be carried out before method step B):
A) defining value ranges for the measurement parameters of the parameter sets, wherein the parameters of the parameter sets are generated in method steps B) and E) within these value ranges.

Embodiments of the invention further provide a device for determining an optimized parameter set with a method described here, wherein the device has a measuring device to carry out the measurements in method step C) and a computer to carry out the further method steps. The computer can be part of the measuring device.

The computer can have software with an algorithm to control the measuring device.

The measuring device is preferably designed in the form of an OCT measuring device or a pyrometry measuring device.

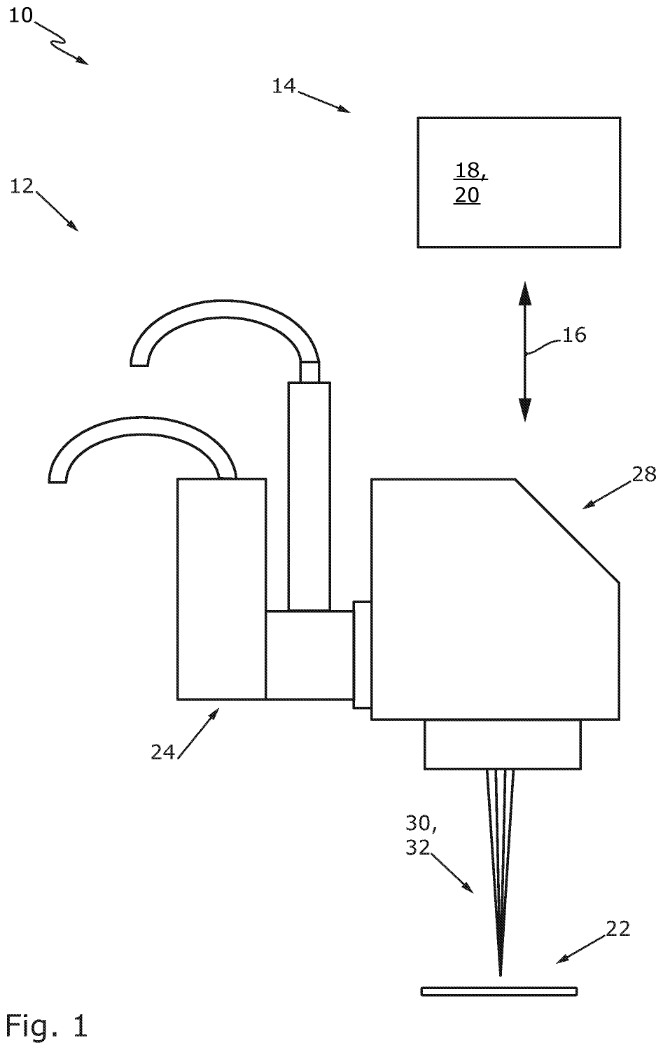

FIG. 1 shows a device 10 having a measuring device 12 and a computer 14. The computer 14 has a wired and/or wireless connection 16 to the measuring device 12. The computer 14 has software 18 having an algorithm 20 to control the measuring device 12.

The measurement with the measuring device 12 is carried out with the setting of a plurality of parameters. The measurement parameters are predefined by the computer 14. Before and/or during the measurement, the measuring device 12 communicates the measurement result (“the measurement”) with a multiplicity of measuring points to the computer 14.

The measuring device 12 is designed in the form of an optical coherence tomography (OCT) measuring device. The measuring device 12 has an OCT scanner 24 for the measurement of a measuring element 22. In addition, a laser processing optical element 28 can be provided for the processing of the measuring element 22. An OCT measuring beam 30 is injected into the measuring device 12. A processing laser beam 32 can be injected in addition to this. The measuring device 12 can have deflection mirrors and/or beam splitters as an alternative or in addition to the devices shown.

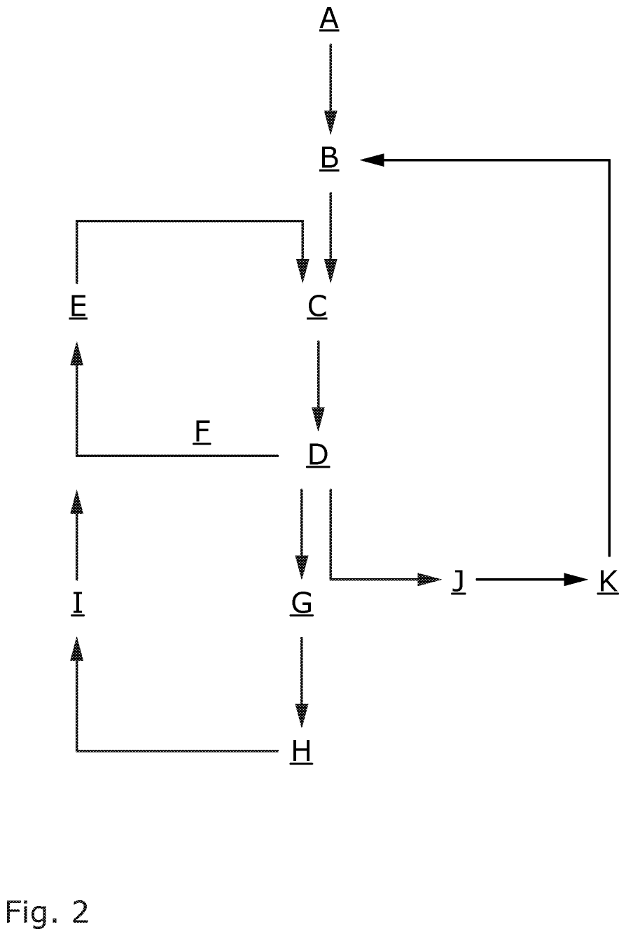

The measurement parameters (“parameter set”) used in the measurement are optimized with the method according to embodiments of the invention. This is explained in FIG. 2.

FIG. 2 shows the sequence of one embodiment of the method according to embodiments of the invention:

in method step A), value ranges are defined for measurement parameters of the parameter sets, wherein the parameters of the parameter sets are generated in method steps B) and E) within these value ranges.

In method step B), n parameter sets are generated within the previously defined value ranges. This is performed B1) randomly; or B2) by means of a default initial parameterization; or B3) through measurement of the measuring element 22 with a default initial parameterization and determination of one or more nearest neighbours of the default initial parameterization.

In method step C), n measurements of the measuring element 22 are carried out and stored in each case with one parameter set, wherein each measurement has a multiplicity of measuring points.

In method step D, the n measurements from method step C) are evaluated with an evaluation function. The evaluations are stored.

In method step E), a loop is executed. In method step E), n new parameter sets are generated. The generation is carried out by applying crossover operators and/or mutation operators to the parameter sets used in method step C). The generation is carried out E1) randomly; or E2) using artificial intelligence which adapts its target function by means of online learning methods and the previously produced evaluations.

The loop of method steps C), D) and E) is repeated m times according to method step F).

After m repetitions, all measurements carried out in method step C) are averaged in method step G).

The smallest possible region of interest (ROI) in the averaged measurement is then determined in method step H). In this ROI, the evaluation function exceeds a defined threshold value.

In method step I), and further loop is executed: method steps C), D), E) and F) are carried out o times, wherein method step D) is modified in such a way that the evaluation function is applied within the ROI only.

In method step J), after the o repetitions, the optimization of the parameter sets is ended and a parameter set evaluated as good is output.

In method step K), at least this parameter set evaluated as good is stored. This parameter set can be used in a subsequent method in method step B).

To provide a synopsis of both figures of the drawing, embodiments of the invention relate to a method and a device 10 for determining an optimized parameter set for a measurement with a measuring device 12. For this purpose, n m measurements in particular are carried out and evaluated, are preferably averaged, and a region of interest (ROI) is determined in the averaged measurement. Subsequently, n*m measurements can be carried out o times, wherein the evaluation is performed in the ROI only. After o repetitions at the latest, the optimization can be ended and a evaluated parameter set evaluated as good can be output and used for a measurement.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGN LIST

10 Device
12 Measuring device
14 Computer
16 Connection (communication)
18 Software
20 Algorithm
22 Measuring element
24 OCT scanner
28 Laser processing optical element
30 OCT measuring beam
32 Processing laser beam
A)-K) Method steps

1. A method for determining an optimized parameter set having a plurality of measurement parameters to carry out a measurement, the method comprising:
C) carrying out and storing n measurements of a measuring element, n being an integer greater than one, each measurement having one parameter set, wherein each measurement has a multiplicity of measuring points;
D) evaluating the n measurements with an evaluation function and storing the evaluation;
E) generating new parameter sets from the parameter sets used in step C);
F) carrying out steps C) to E) multiple times; and
J) outputting at least one parameter set that is evaluated as good.

2. The method according to claim 1, wherein the generation of the new parameter sets in step E) is carried out by applying evolutionary operators to the parameter sets used in step C).

3. The method according to claim 1, wherein each measurement in step C) is carried out in a contactless scan.

4. The method according to claim 3, wherein each measurement in step C) is carried out in an optical coherence tomography measurement or in a pyrometry measurement.

5. The method according to claim 1, wherein the evaluation function comprises an algorithm for evaluating a recording quality of the measurement, and/or a deep convolution neural network.

6. The method according to claim 1, wherein the new parameter sets are generated in step E) randomly.

7. The method according to claim 1, wherein the new parameter sets are generated in step E) using artificial intelligence that adapts a target function by an online learning method and the evaluations of the evaluation function.

8. The method according to claim 1, further comprising, after step F) and before step J):
G) merging all of the measurements carried out in step C);
H) defining a smallest possible region of interest (ROI) in the merged measurements in which the evaluation function exceeds a defined threshold value; and
I) repeating steps C) to F) multiple times, wherein the evaluation function in step D) is applied within the ROI only.

9. The method according to claim 1, further comprising, after step J):
K) storing the at least one parameter set output in step J) in a database.

10. The method according to claim 1, further comprising, before step C):
B) generating the n parameter sets used in step C) randomly, or by a default initial parameterization.

11. The method according to claim 9, further comprising, before step C):
B) generating the n parameter sets used in step C): by carrying out a measurement of the measuring element with a default initial parameterization, and determining one or more nearest neighbours of the default initial parameterization.

12. The method according to claim 10, further comprising, before step B):
A) defining value ranges for the measurement parameters of the parameter sets, wherein the parameters of the parameter sets are generated in steps B) and E) within the value ranges.

13. The method according to claim 11, further comprising, before step B):
defining value ranges for the measurement parameters of the parameter sets, wherein the parameters of the parameter sets are generated in steps B) and E) within the value ranges.

14. A device for determining an optimized parameter set using a method according to claim 1, wherein the device has a measuring device to carry out the measurements in step C) of the method, and a computer to carry out steps D), E), F), and J) of the method.
